(19) United States
(12) Patent Application Publication
(10) Pub. No.: US 2006/0007470 A1
(43) Pub. Date: Jan. 12, 2006

(54) Print control apparatus and printer

(75) Inventor: Kenya Takamidoh, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/175,045

(22) Filed: Jul. 6, 2005

(30) Foreign Application Priority Data
Jul. 6, 2004 (JP) P2004-199038

(51) Int. Cl. G06F 15/00

(52) U.S. Cl. 358/1.14

(57) ABSTRACT

A print control apparatus including: a print medium characteristic information acquisition unit that acquires print medium characteristic information indicating a characteristic of a print medium contained in a print medium container mounted in a printer; a print instruction content information acquisition unit that acquires print instruction content information indicating a content of a print instruction of an image based on image data to the printer; a judgment unit that makes a judgment about a propriety of printing the image based on the image data based on the print medium characteristic information and the print instruction content information; and an output unit that makes an output based on the judgment.

This application is based on Japanese Patent application JP 2004-199038, filed Jul. 6, 2004, the entire content of which is hereby incorporated by reference. This claim for priority benefit is being filed concurrently with the filing of this application.

### BACKGROUND OF THE INVENTION

1. Technical Field of the Invention

The present invention relates to a print control apparatus which performs print control of an image based on image data in a printer and the printer including the same.

2. Detailed Description of the Invention

There is known, as a related art, a portable printer which prints an image based on image data transmitted from a cellular phone with a camera onto an instant film (for example, JP-A-2002-92350, hereafter “JPA '350”).

As the instant film, in addition to one in which an outer frame portion except a portion where an image is to be printed is plain, like an instant film 1 shown in FIG. 12A, one in which a character 2 is previously printed in its outer frame portion is also on sale.

According to a system disclosed in JPA '350, for example, a frame image 4 (hereinafter also referred to as content) downloaded from a content provider by a cellular phone and including a character 3 as shown in FIG. 12B is combined with an image photographed by the cellular phone to create an original image, this original image is printed on the instant film 1, and a photograph 5 as shown in FIG. 12C can be formed.

In the case where the copyrights of the character 2 and the character 3 are managed, and the respective characters are literary works of different companies (especially competing companies), it is not desirable for the competing companies that something like the photograph 5 can be formed. When there is a scheme to prevent such an undesirable situation, the owner of copyright can perform such a service that a frame image including a character whose copyright is required to be managed is delivered to a user. However, under the present circumstances, since there is no scheme to prevent the above situation, the owner of copyright is reluctant to perform the service as stated above. From such reason, the photograph 5 as stated above can be formed only in a case where the character 2 and the character 3 are characters whose copyrights are not managed. However, there is naturally a desire to form something like the photograph 5 by using a character whose copyright is managed.

Besides, in a related art portable printer, a container for containing plural instant films is mounted in the inside of the portable printer, so that images can be printed on the plural instant films. However, when the container is once mounted in the portable printer, thereafter, it is impossible to confirm what kind of instant film is in the container. Thus, for example, even in the case where the expiration date of the instant film has expired, an image can be printed on the instant film, and a photograph with excellent picture quality desired by the user can not be obtained. Besides, even in the case where the kind of the instant film is different from what the user intends, an image can be printed on the instant film, and a photograph desired by the user can not be obtained.

### SUMMARY OF THE INVENTION

The invention has been made in view of the above circumstances, and provides a print control apparatus and a printer which can perform print control so that printing against the intention of the owner of copyright of a character and the intention of a user is not performed.

A print control apparatus of the invention is a print control apparatus which performs print control of an image based on image data in a printer, and includes a print medium characteristic information acquisition unit to acquire print medium characteristic information indicating a characteristic of a print medium contained in a print medium container mounted in the printer, a print instruction content information acquisition unit to acquire print instruction content information indicating contents of a print instruction of the image based on the image data to the printer, a judgment unit to judge, based on the print medium characteristic information and the print instruction content information, propriety of printing the image based on the image data, and an output unit to make an output based on the judgment.

By this structure, based on the characteristic of the print medium contained in the print medium container mounted in the printer and the contents of the print instruction to the print medium, it is possible to control the propriety of printing the image onto the print medium, and it becomes possible to prevent unintentional printing from being performed by the printer.

Preferably, in the print control apparatus of the invention, the print medium characteristic information includes first identification information to identify a first character previously printed on the print medium contained in the print medium container, the print instruction content information includes second identification information to identify a second character included in the image data as a print object to the print medium, and based on print propriety information indicating the propriety of printing the first character and the second character onto a same print medium, the first identification information, and the second identification information, the judgment unit judges the propriety of printing the image based on the image data.

By this structure, it becomes possible to prevent printing against the intention of the owner of copyright of the character from being performed.

Preferably, in the print control apparatus of the invention, the print medium characteristic information includes print medium kind information indicating a kind of the print medium contained in the print medium container, and the judgment means judges that printing of the image based on the image data can not be performed in a case where a kind of a print medium most suitable for a printing condition indicated by the print instruction content information is not coincident with the kind of the print medium indicated by the print medium kind information.

By this structure, it is possible to prevent the image from being printed on the print medium of the kind which is not intended by the user of the printer.

Preferably, in the print control apparatus of the invention, the print medium characteristic information includes expiration date information indicating an expiration date of the print medium contained in the print medium container, and the judgment unit judges that printing of the image based on the image data can not be performed in a case where a date when the print instruction indicated by the print instruction content information is issued exceeds the expiration date indicated by the expiration date information.

By this structure, it is possible to prevent the image from being printed on the print medium exceeding the expiration date.

A printer of the invention is a printer which prints an image based on image data received from a portable terminal apparatus, and includes the print control apparatus, a housing part to house the print medium container, and a reading unit to read the print medium characteristic information from a storage medium provided at the print medium container housed in the housing part, the print instruction content information acquisition unit acquires the print instruction content information from the portable terminal apparatus, and the print medium characteristic information acquisition unit acquires the print medium characteristic information from the reading unit.

By this structure, based on the characteristic of the print medium contained in the print medium container mounted in the printer and the print instruction content to the print medium, it is possible to control the propriety of printing the image on the print medium, and it becomes possible to prevent unintentional printing from being performed by the printer.

Preferably, a printer of the invention is a printer which prints an image based on image data received from a portable terminal apparatus, and includes the print control apparatus, a housing part to house the print medium container, a reading unit to read the print medium characteristic information from a storage medium provided at the print medium container housed in the housing part, and a storage unit to previously store the print propriety information, the print instruction content information acquisition unit acquires the print instruction content information from the portable terminal apparatus, and the print medium characteristic information acquisition unit acquires the print medium characteristic information from the reading unit.

Preferably, a printer of the invention is a printer which prints an image based on image data received from a portable terminal apparatus, and includes the print control apparatus, a housing part to house the print medium container, a reading unit to read the print medium characteristic information from a storage medium provided at the print medium container housed in the housing part, and a print propriety information acquisition unit to acquire the print propriety information from the portable terminal apparatus, the print instruction content information acquisition unit acquires the print instruction content information from the portable terminal apparatus, and the print medium characteristic information acquisition unit acquires the print medium characteristic information from the reading unit.

Preferably, a printer of the invention is a printer which prints an image based on image data received from a portable terminal apparatus, and includes the print control apparatus, a housing part to house the print medium container, and a reading unit to read the print medium characteristic information from a storage medium provided at the print medium container housed in the housing part, the print instruction content information acquisition unit acquires the print instruction content information from the portable terminal apparatus, and the print medium characteristic information acquisition unit acquires the print medium characteristic information from the reading unit.

Preferably, in the printer of the invention, the print medium container includes a containing part which contains the print medium and a cover part which covers the print medium contained in the containing part and can be detached from the containing part, the storage medium is provided at the cover part, and the reading unit is located in a vicinity of a discharge port for discharging the print medium to an outside of the printer, and reads the print medium characteristic information from the storage medium attached to the cover part when the cover part is removed from the discharge port to the outside in a state where the print medium container is housed in the housing part.

By this structure, it becomes possible to realize the reading unit by the simple structure, and it is possible to prevent the size of the printer from increasing.

Preferably, in the printer of the invention, the print medium container includes a containing part which contains the print medium and a cover part which covers the print medium contained in the containing part and can be detached from the containing part, the storage medium is provided at the cover part, and the reading unit is located in a vicinity of a discharge port for discharging the print medium to an outside of the printer, and reads the print medium characteristic information and the print propriety information from the storage medium attached to the cover part when the cover part is removed from the discharge port to the outside in a state where the print medium container is housed in the housing part.

By this structure, it becomes possible to realize the reading unit by the simple structure, and it is possible to prevent the size of the printer from increasing.

In the printer of the intention, the storage medium preferably includes a wireless tag.

By this structure, the interpolation of information stored in the storage medium can be prevented.

According to the invention, it is possible to provide the print control apparatus which can perform the print control so that the printing against the intention of the owner of copyright of a character and the intention of the user is not performed, and the printer.

### BRIEF DESCRIPTION OF THE DRAWINGS

FIG. 1 is a view showing a rough structure of a print system for explaining a first embodiment of the invention.

FIG. 2 is a view for explaining an inner block of a cellular phone of the print system for explaining the first embodiment of the invention.

FIG. 3 is a view for explaining an inner block of a portable printer of the print system for explaining the first embodiment of the invention.

FIG. 4 is a view showing a rough structure of an instant film.

FIG. 5 is a view showing an inner structure of the portable printer of the print system for explaining the first embodiment of the invention.

FIG. 6 is a view showing a rough structure of a container mounted in the portable printer of the print system for explaining the first embodiment of the invention.

FIG. 7 is a view showing a print propriety table.

FIG. 8 is a view showing an operation flow of the portable printer for explaining the first embodiment of the invention.

FIG. 9 is a view showing an operation flow of a portable printer for explaining a second embodiment of the invention.

FIG. 10 is a view showing an operation flow of a portable printer for explaining a third embodiment of the invention.

FIG. 11 is a view showing a modified example of a storage medium attached to a cover part of a container.

FIG. 12A is a view showing an example of an instant film, FIG. 12B is a view showing an example of a frame, and FIG. 12C is a view showing a composite photograph.

### DETAILED DESCRIPTION OF THE INVENTION

Hereinafter, a print system for explaining embodiments of the invention will be described with reference to the drawings.

### First Embodiment

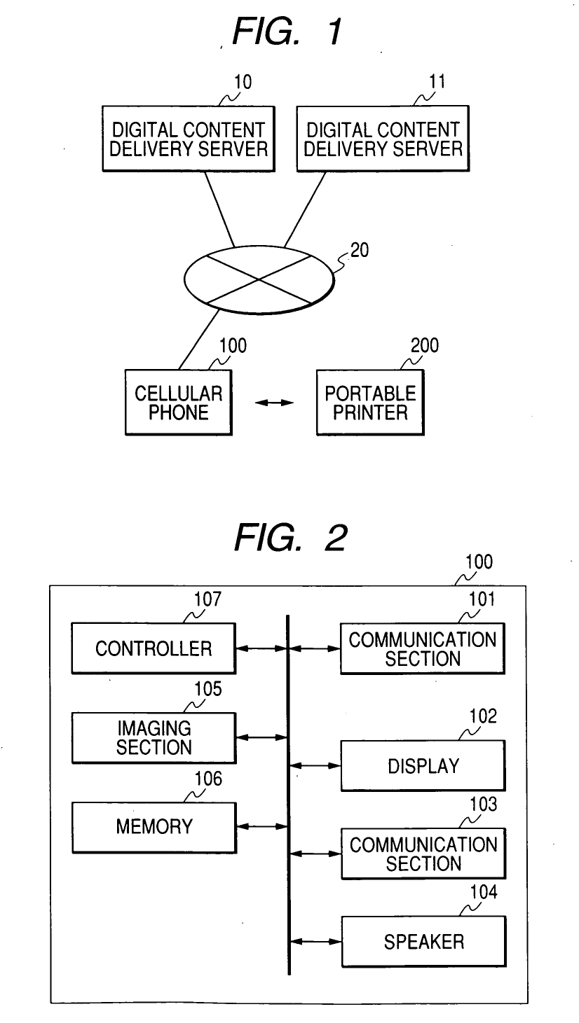

FIG. 1 is a view showing a rough structure of a print system for explaining a first embodiment of the invention. The print system shown in the drawing includes digital content delivery servers 10 and 11 to deliver digital content (image data) including a character requiring copyright management, an Internet 20, a cellular phone 100 as an example of a portable terminal apparatus, such as a PDA or a cellular phone, connected to the Internet 20, and a portable printer 200.

In digital content delivered from the digital content delivery servers 10 and 11, identification information (ID) to identify a character included in the digital content is recorded in, for example, a header of image data.

FIG. 2 is a main part block diagram for explaining an inner structure of the cellular phone 100.

As shown in the drawing, the cellular phone 100 includes a communication section 101 connected to the Internet 20 and performing transmission/reception of data, a display 102, such as an LCD, to display various information, a communication section 103 to communicate with the portable printer 200, a speaker 104 to output a sound, an imaging section 105 to take a picture of a subject by an imaging device such as a CCD or CMOS image sensor to create photograph image data, a memory 106 such as a flash memory or an EEPROM, and a controller 107 to overall control the respective parts.

The communication section 103 communicates with the portable printer 200 by a short distance wireless communication interface such as an infrared communication interface. Incidentally, the communication section 103 may be connected to the portable printer 200 through a communication cable or may be directly connected to the portable printer 200 through mutual connectors to make communication.

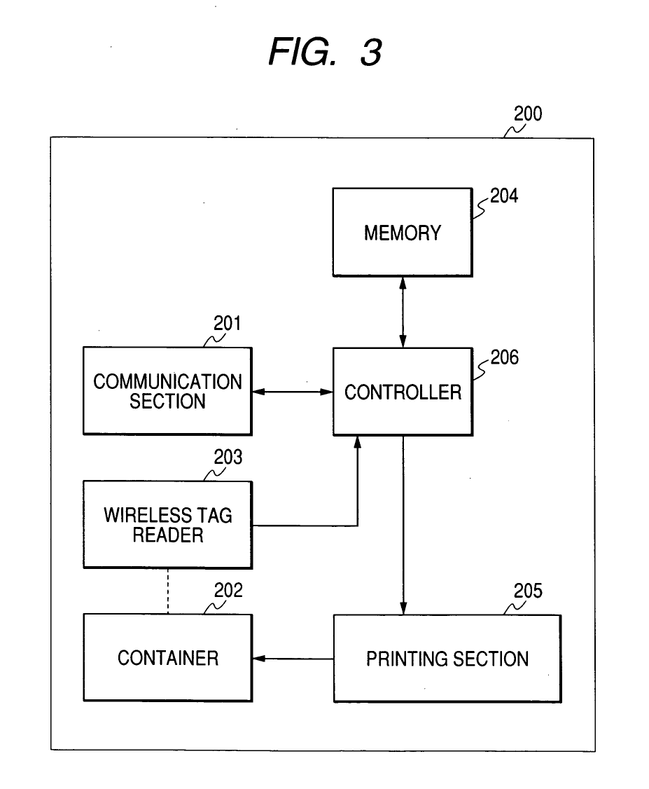

FIG. 3 is a main part block diagram showing an inner structure of the portable printer 200.

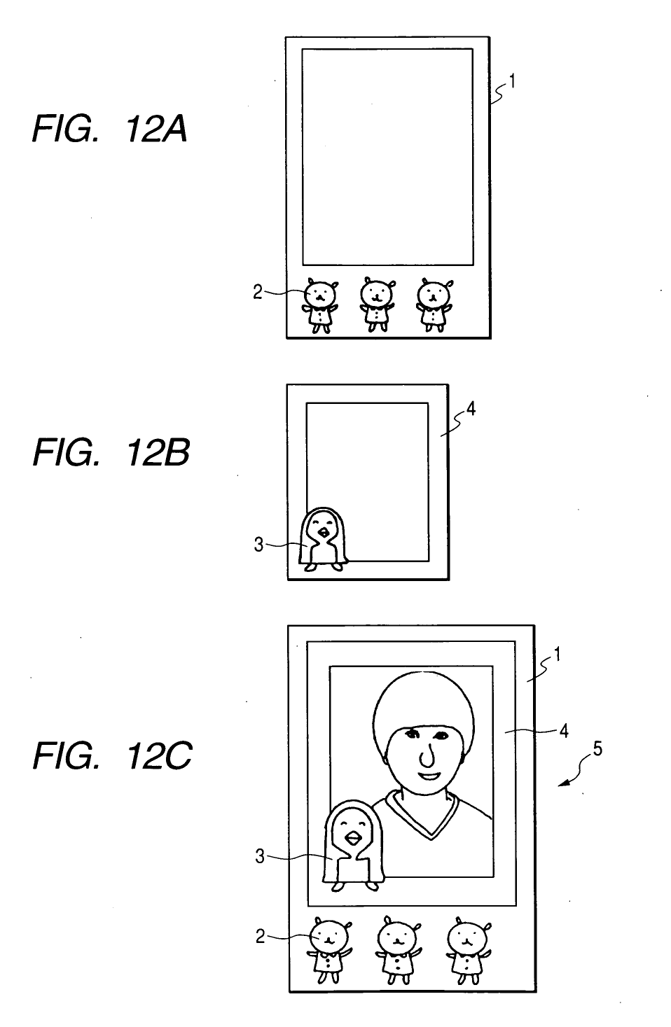

The portable printer 200 includes a communication section 201 communicating with the cellular phone 100, a detachable/attachable container 202 for containing plural instant films 30 as an example of a print medium, a wireless tag reader 203, a memory 204, a printing section 205, and a controller 206. In this embodiment, as the instant film 30, one having the same design as the instant film 1 shown in FIG. 12 is used.

The communication section 201 performs communication with the cellular phone 100 by the short distance wireless communication interface such as the infrared communication interface. Incidentally, the communication section 201 may be connected to the cellular phone 100 through a communication cable or may be directly connected to the cellular phone 100 through mutual connectors to perform communication. Data received by the communication section 201 is inputted to the controller 206.

The container 202 is integrated with an after-mentioned wireless tag 35. Identification information (ID) to identity a character previously printed on the plural instant films 30 contained in the container 20 is stored in an IC chip embedded in the wireless tag 35.

The wireless tag reader 203 reads the ID written in the IC chip of the wireless tag 35 integrated with the container 202 and inputs it to the controller 206.

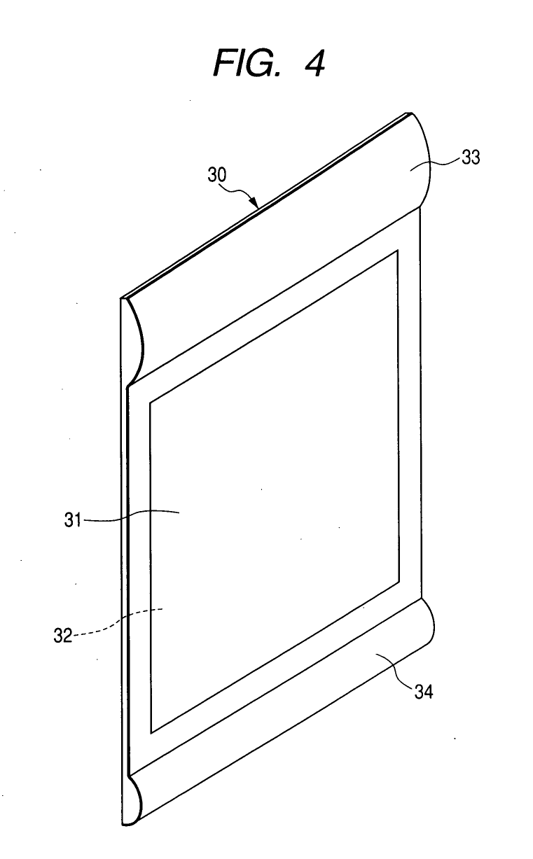

FIG. 4 is a view showing a rough structure of the instant film 30.

The instant film 30 includes a photosensitive sheet 31, an image receiving sheet 32 at the back side of the photosensitive sheet 31, a developing solution pod 33 which is positioned above the photosensitive sheet 31 and the image receiving sheet 32 and in which a developing solution is enclosed, and a trap part 34 which is positioned under the photosensitive sheet 31 and the image receiving sheet 32 and absorbs a surplus developing solution.

Next, the inner structure of the portable printer 200 will be described.

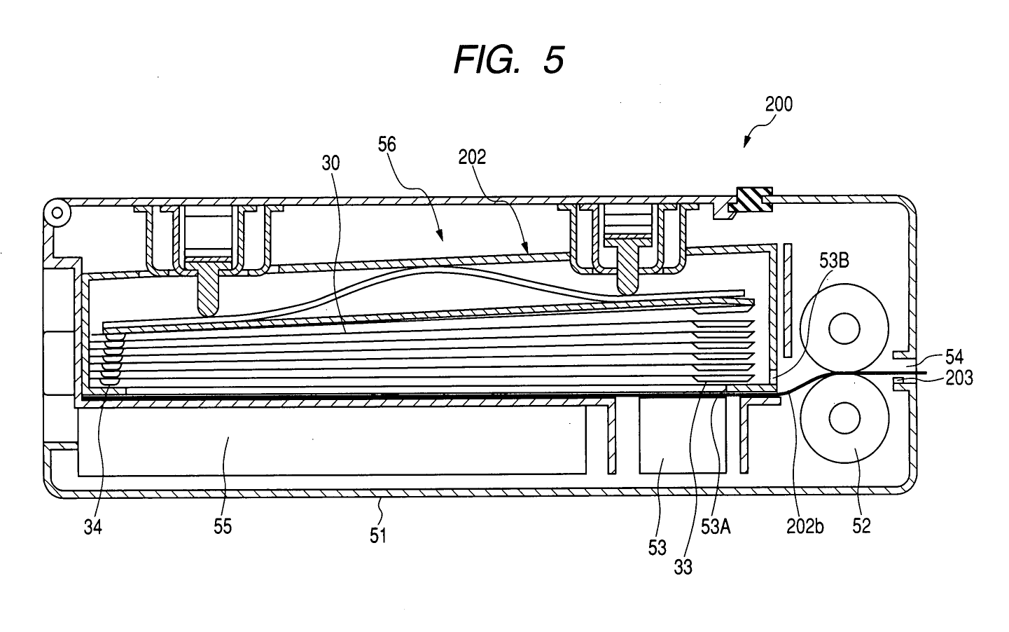

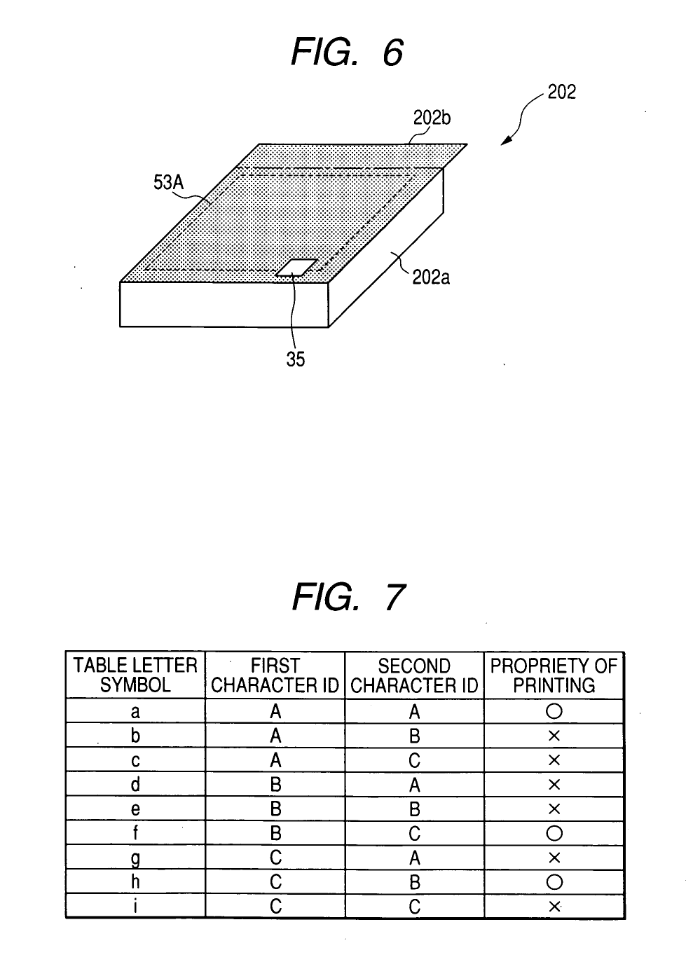

FIG. 5 is a sectional view showing the inner structure of the portable printer 200. FIG. 6 is a perspective view showing a rough structure of the container 202.

As shown in FIG. 5, a pair of spreading rollers 52, a multi-light emitting head 53, a housing part 56 for housing the container 202, a discharge port 54 for the instant films 30, a battery containing part and a circuit board 55 are provided in an exterior case 51 of the portable printer 200. With respect to the instant films 30, the lowermost instant film 30 in the drawing is sent out from an opening 53B of the container 202 by a not-shown claw mechanism, and is discharged from the discharge port 54 while the developing solution is spread by the pair of spreading rollers 52.

On the other hand, the multi-light emitting head 53 is fixedly disposed below an exposure opening 53A of the container 202 so that its longitudinal direction crosses the transport direction of the instant film 30 at right angles, emits light in synchronization with the transport operation of the instant film 30 and based on the image data to be printed, and forms a latent image on the instant film 30.

As shown in FIG. 6, the container 202 includes a hollow structure containing part 202a for containing the plural instant films 30, and a cover part 202b for covering the plural instant films 30 contained in the containing part 202a. The cover part 202b can be detached from the containing part 202a, and functions as a light shielding member to prevent light from being incident on the photosensitive sheets 31 of the plural instant films 30 from the exposure opening 53A. The wireless tag 35 is attached to the outside surface of the cover part 202b. The wireless tag 35 is attached to, for example, an end part of the cover part 202b opposite to an end part at the side of the discharge port 54 in a state where the container 202 is housed in the housing part 56.

The wireless tag reader 203 is located in the vicinity of the discharge port 54. In the state where the container 202 is housed in the housing part 56, when the user of the portable printer 200 pulls out the cover part 202b from the discharge port 54 to the outside, and the wireless tag 35 passes through the vicinity of the wireless tag reader 203, the wireless tag reader 203 reads the information stored in the IC chip of the wireless tag 35 and inputs it to the controller 206,

Incidentally, since the detailed structure of the portable printer 200 is disclosed in JP-A-2002-92350, please refer to this.

With reference to FIG. 3 again, the memory 204 stores a print propriety table indicating the propriety of printing a character (hereinafter referred to as a first character) previously printed on the plural instant films 30 contained in the container 202 and a character (hereinafter referred to as a second character) included in digital content delivered from the digital content de livery servers 10 and 11 onto the same instant film 30. The print propriety table is created by reflecting the intention of the owner of copyright participating in this system. FIG. 7 is a view showing the print propriety table. The print propriety table is created on the assumption that the owners of copyrights of characters B and C are the same, and the owner of copyright of the characters B and C and the owner of copyright of character A are competitive. Besides, the character A is set such that the plural characters exist in all the world, and each of the characters B and C is set such that only one character exists in all the world.

As shown in FIG. 7, in “a” of the print propriety table, ┌O┘ is set which indicates that in the case where both the first character and the second character are the ┌character A┘, the first character and the second character can be printed on the same instant film 30. In this case, since the owners of copyrights of the two characters to be printed are the same, and the character A is not set such that only one character exists in all the world, even if both the first character and the second character are the ┌character A┘, the printing is possible.

In “b” of the print propriety table, ┌x┘ is set which indicates that in the case where the first character is the ┌character A┘ and the second character is the ┌character B┘, the first character and the second character can not be printed on the same instant film 30. In this case, since the owner of copyright of the character A and the owner of copyright of the character B are competitive, the printing is impossible. The same is the case with “c”, “d” and “g” of the print propriety table.

In “e” of the print propriety table, ┌x┘ is set which indicates that in the case where both the first character and the second character are the ┌character B┘, the first character and the second character can not be printed on the same instant film 30. In this case, since the owners of copyrights of the two characters to be printed are the same, it appears that printing should be possible. However, since the character B is set such that only one character exists in all the world, in the case where both the first character and the second character are the ┌character B┘, the printing is impossible. The same is the case with “I” of the print propriety table.

In “f” of the print propriety table, ┌O┘ is set which indicates that in the case where the first character is the ┌character B┘ and the second character is the ┌character C┘, the first character and the second character can be printed on the same instant film 30. In this case, since the owners of copyrights of the character B and the character C are the same, the printing is possible. The same is the case with “h” of the print propriety table.

With reference to FIG. 3 again, the printing section 205 prints an image based on the image data inputted from the controller 206 onto the instant film 30, and printing is performed by the control of the controller 206.

The controller 206 acquires the ID of the first character from the wireless tag reader 203, and judges, based on the ID of the first character, the ID of the second character included in the header of the image data included in the print instruction content information indicating the contents of a print instruction acquired through the communication section 201, and the print propriety table stored in the memory 204, whether or not the printing of the image based on the image data as the print object can be performed. Then, based on the judgment result, a print instruction is outputted to the printing section 205, or information notifying that printing is impossible is transmitted to the cellular phone 100 through the communication section 201. The print instruction content information is information indicating the contents of the print instruction to the portable printer 200, and includes, for example, image data to be printed, information of printing conditions, information of date when the print instruction is issued, and the like.

Hereinafter, an operation of the portable printer 200 will be described. In the following, a description will be given to the operation at the time when the user of the cellular phone 100 downloads a frame (digital content) as shown in FIG. 12B from the digital content delivery server 10, creates original image data in which the image data of a person photographed by the imaging section 105 of the cellular phone 100 is combined with the frame, and printing of the image based on the original image data is performed. Since the original image data is a composite image of the photograph image data and the frame, the ID of the second character remains recorded in the header.

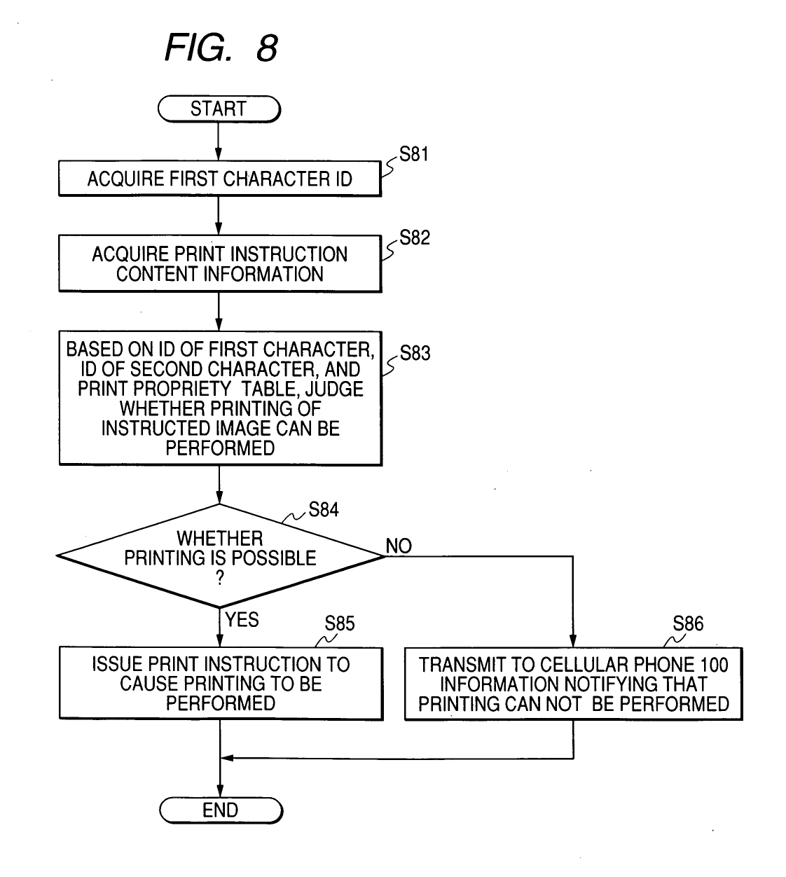

FIG. 8 is a view showing an operation flow of the portable printer of the print system for explaining the embodiment of the invention.

First, the user puts a new container 202 into the housing part 56 of the portable printer 200. When the container 202 is housed in the housing part 56, there occurs a state in which a part of the cover part 202b of the container 202 protrudes from the discharge port 54 to the outside as shown in FIG. 5. The user pulls the protruding part of the cover part 202b with fingers, separates the cover part 202b from the container 202, and takes it out to the outside. At this time, the wireless tag reader 203 of the portable printer 200 reads the ID of the first character from the IC chip of the wireless tag 35 attached to the outside surface of the cover part 202b, and the controller 206 acquires the ID of the first character read by the wireless tag reader 203 (S81). The controller 206 stores the ID of the first character acquired here into the memory 204, and after this, until the container 202 is exchanged with a new one, a judgment as to the propriety of printing is made by using the ID of the first character stored in the memory 204.

When the user operates a not-shown operation section of the cellular phone 100 and specifies original image data to be printed, the original image data is transmitted as the print instruction content information from the cellular phone 100 to the portable printer 200.

The controller 206 of the portable printer 200 acquires the original image data through the communication section 201 (S82), and based on the ID of the first character acquired at S81, the ID of the second character included in the header of the original image data, and the print propriety table stored in the memory 204, a judgment is made as to whether or not printing of the image based on the original image data is possible (S83). For example, in the case where the acquired ID of the first character is the ┌character B┘, and the acquire ID of the second character is the ┌character C┘, since the character B and the character C can be printed on the same instant film 30, it is judged that the printing is possible.

In the case where the acquired ID of the first character is the ┌character A┘, and the acquired ID of the second character is the ┌character B┘, since the character A and the character B can not be printed on the same instant film 30, it is judged that the printing is impossible.

By the above judgment, in the case where the printing is possible (S84: YES), the controller 206 inputs the original image data to the printing section 205 and issues a print instruction, and performs control to cause the image based on the original image data to be printed on the instant film 30 (S85). By this, the image based on the original image data is printed on the instant film 30, and the instant film 30 is discharged from the discharge port 54.

By the above judgment, in the case where the printing is impossible (S84: NO), the controller 206 does not issue to the printing section 205 the print instruction of the image based on the original image data the printing of which is instructed, creates notification information for notifying that the image based on the original image data the printing of which is instructed can not be printed, and transmits it to the cellular phone 100 through the communication section 201 (S86). By this, on the display 102 of the cellular phone 100, such a display that ┌Image instructed now can not be printed.┘ is produced. Incidentally, this notification may be performed at the portable printer 200 side, or can also be outputted as a sound.

As described above, according to the portable printer 200, when an image including a character requiring the copyright management is printed on the instant film 30 on which a character requiring the copyright management is previously printed, a judgment as to whether or not the printing is possible is made by using the print propriety table created by reflecting the intention of the owner of copyright of the character. Thus, in the case where printing against the intention of the owner of copyright of the character is about to be performed, the printing can be made not to be performed. Accordingly, the owner of copyright of the character can volunteer to perform the delivery service of a frame image using the character, or the like, and the useful service for both the owner of copyright and the user can be realized.

Incidentally, in this embodiment although the example in which the print propriety table for judging the propriety of printing is previously stored in the memory 204 of the portable printer 200 has been described, it may be stored in, for example, the wireless tag 35, together with the ID of the first character. In this case, the controller 206 has only to acquire the print propriety table together with the ID of the first character at S81 of FIG. 8.

Besides, the print propriety table may be stored in the memory 106 of the cellular phone 100. In this case, when the original image data is transmitted from the cellular phone 100 to the portable printer 200, the print propriety table is also transmitted, and the controller 206 has only to acquire this through the communication section 201. When the print propriety table can be downloaded through the Internet 20, it is possible to immediately cope with a case where a new character appears.

Besides, in this embodiment, although the print propriety is judged in the portable printer 200, this judgment may be performed in the cellular phone 100. In this case, the print propriety table is stored in the memory 106, and the controller 107 of the cellular phone 100 makes an acquisition request to the portable printer 200 for the ID of the first character, and in response to this request, the controller 206 of the portable printer 200 transmits the ID of the first character to the cellular phone 100 through the communication section 201. The controller 107 of the cellular phone 100 having acquired the ID of the first character uses the ID of the second character included in the header of the original image data the printing of which is instructed, the ID of the first character, and the print propriety table stored in the memory 106 and makes a judgment as to the propriety of printing. When the printing is impossible, a predetermined display is produced on the display 102, and when the printing is possible, the original image data is transmitted from the cellular phone 100 to the portable printer 200 and the printing is made to be performed.

### Second Embodiment

In the print system described in the first embodiment, based on the ID of the character included in the image to be printed by the portable printer 200 and the ID of the character printed on the instant film 30, it is judged whether or not the image can be printed. In a second embodiment, in the case where the kind of an instant film most suitable for a printing condition of an image to be printed is not coincident with the kind of the instant film 30 contained in the container 202 mounted in the portable printer 200, the image is made unable to be printed. Since a system structure of the second embodiment is almost equal to the print system described in the first embodiment, only different portions will be described below.

Kind information indicating the kind of the instant film 30 contained in the container 202 is stored in the IC chip of the wireless tag 35 attached to the cover part 202b of the container 202 attachable/detachable to/from the portable printer 200. In the instant films 30, optimum kinds of instant films are prepared for various printing conditions (normal printing, division printing, high quality printing, etc.).

Hereinafter, the operation of the portable printer of the print system of the second embodiment will be described.

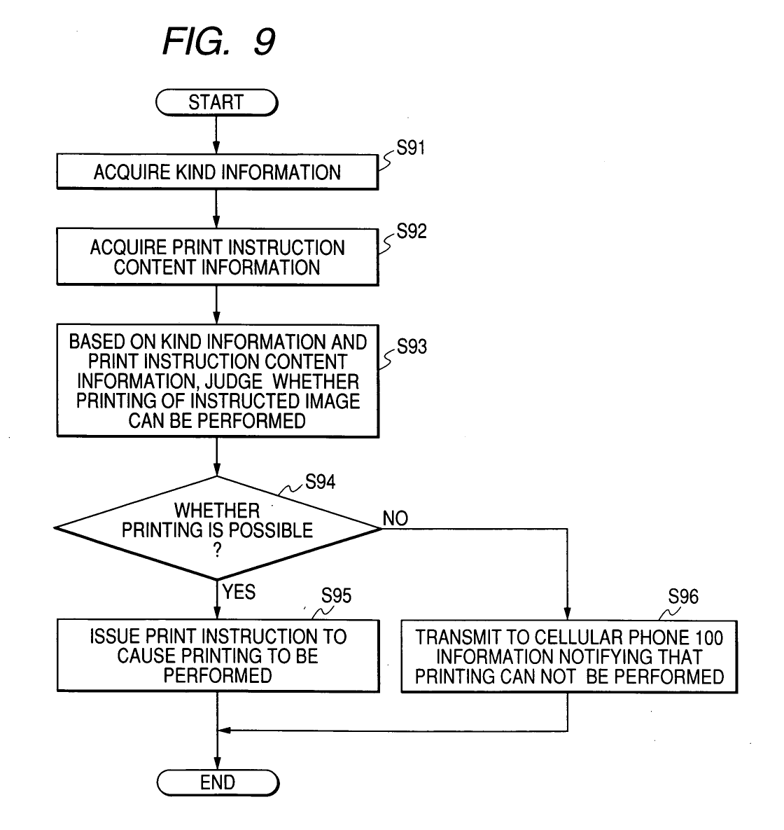

FIG. 9 is a view showing an operation flow of the portable printer of the print system for explaining the second embodiment of the invention.

First, the user puts a new container 202 into the housing part 56 of the portable printer 200. When the container 202 is housed in the housing part 56, there occurs a state in which a part of the cover part 202b of the container 202 protrudes from the discharge port 54 to the outside as shown in FIG. 5. The user pulls the protruding part of the cover part 202b with fingers, separates the cover part 202b from the container 202, and takes it out to the outside. At this time, the wireless tag reader 203 of the portable printer 200 reads the kind information of the instant film 30 from the IC chip of the wireless tag 35 attached to the outside surface of the cover part 202b, and the controller 206 acquires the kind information read by the wireless tag reader 203 (S91). The controller 206 stores the kind information acquired here into the memory 204, and after this, until the container 202 is exchanged with a new one, a judgment as to the propriety of printing is made by using the kind information stored in the memory 204.

When the user operates a not-shown operation section of the cellular phone 100 and specifies original image data to be printed (it is assumed that copyright management is not required for the image data) and a printing condition, the image data and information indicating the printing condition are transmitted as print instruction content information from the cellular phone 100 to the portable printer 200.

The controller 206 of the portable printer 200 acquires the print instruction content information through the communication section 201 (S92), and based on the kind information and the print instruction content information, it is judged whether or not printing of the image based on the image data included in the print instruction content information is possible (S93). In the case where the kind of the instant film 30 indicated by the kind information is coincident with the kind of the instant film which is indicated by the print instruction content information and most suitable for the printing condition, the controller 206 judges that printing is possible, and when not coincident, a judgment that printing is impossible is made.

By the above judgment, in the case where the printing is possible (S94: YES), the controller 206 inputs the image data and the printing condition to the printing section 205 and issues a print instruction, and performs control to cause the image based on the image data to be printed on the instant film 30 (595). By this, the image based on the image data is printed on the instant film 30, and the instant film 30 is discharged from the discharge port 54.

By the above judgment, in the case where the printing is impossible (S94: NO), the controller 206 does not issue to the printing section 205 the print instruction of the image based on the image data the printing of which is instructed, creates notification information for notifying that the image based on the image data the printing of which is instructed can not be printed, and transmits it to the cellular phone 100 through the communication section 201 (S96). By this, on the display 102 of the cellular phone 100, such a display that ┌since the printing condition instructed now is not adapted to the kind of the film mounted in the printer, printing can not be performed.┘ is produced. Incidentally, this notification may be performed at the portable printer 200 side, or can also be outputted as a sound.

As described above, according to the portable printer 200 of the second embodiment, in the case where the instant film 30 most suitable for the printing condition specified by the user is not mounted in the portable printer 200, the image is not printed. Thus, it is possible to prevent such a case that an image is printed on an instant film not suitable for the printing condition specified by the user and a photograph not intended by the user is formed,

Incidentally, in the second embodiment, although the propriety of printing is judged in the portable printer 200, this judgment may be made in the cellular phone 100. In this case, the controller 107 of the cellular phone 100 makes an acquisition request to the portable printer 200 for the kind information, and the controller 206 of the portable printer 200 transmits the kind information through the communication section 201 to the cellular phone 100 in response to this request. The controller 107 of the cellular phone 100 having acquired the kind information acquires the print instruction content information, and uses the acquired print instruction content information and the kind information to make a judgment as to the propriety of printing. When the printing is impossible, a predetermined display is produced on the display 102, and when the printing is possible, the image data is transmitted from the cellular phone 100 to the portable printer 200 and the printing is made to be performed.

### Third Embodiment

In the print system described in the first embodiment, based on the ID of the character included in the image to be printed by the portable printer 200 and the ID of the character printed on the instant film 30, it is judged whether or not the image can be printed. In a third embodiment, in the case where expiration date of an instant film has expired, the image is made unable to be printed. Since a system structure of the third embodiment is almost equal to the print system described in the first embodiment, only different portions will be described below.

Expiration date information indicating the expiration date of an instant film contained in the container 202 is stored in the IC chip of the wireless tag 35 attached to the cover part 202b of the container 202 attachable/detachable to/from the portable printer 200. The expiration date is a date when the picture quality of an image printed on the instant film becomes unable to be kept excellent, and is uniquely set by a maker of the instant film.

Hereinafter, the operation of the portable printer of the print system of the third embodiment will be described

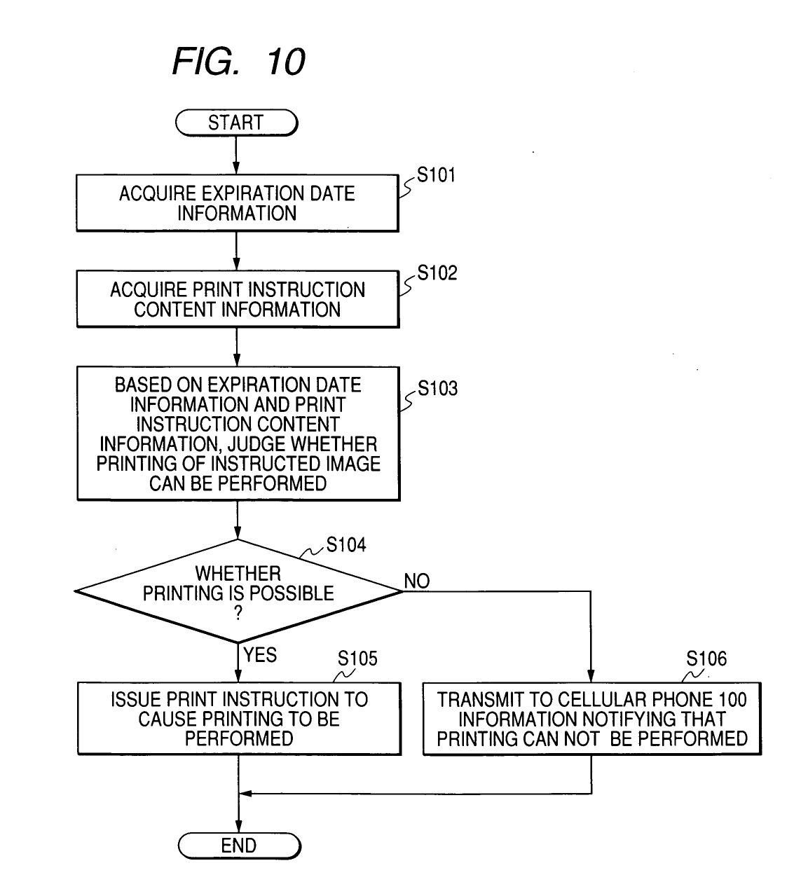

FIG. 10 is a view showing an operation flow of the portable printer of the print system for explaining the third embodiment of the invention.

First, the user puts a new container 202 into the housing part 56 of the portable printer 200. When the container 202 is housed in the housing part 56, there occurs a state in which a part of the cover part 202b of the container 202 protrudes from the discharge port 54 to the outside as shown in FIG. 5. The user pulls the protruding part of the cover part 202b with fingers, separates the cover part 202b from the container 202, and takes it out to the outside. At this time, the wireless tag reader 203 of the portable printer 200 reads the expiration date information of the instant film 30 from the IC chip of the wireless tag 35 attached to the outside surface of the cover part 202b, and the controller 206 acquires the expiration date information read by the wireless tag reader 203 (S101). The controller 206 stores the expiration date information acquired here into the memory 204, and after this, until the container 202 is exchanged with a new one, a judgment as to the propriety of printing is made by using the expiration date information stored in the memory 204.

When the user operates a not-shown operation section of the cellular phone 100 and specifies image data to be printed (it is assumed that copyright management is not required for the image data), the image data and information indicating the date when the print instruction is issued are transmitted as print instruction content information from the cellular phone 100 to the portable printer 200.

The controller 206 of the portable printer 200 acquires the print instruction content information through the communication section 201 (S102), and based on the expiration date information and the print instruction content information, it is judged whether or not printing of the image based on the image data included in the print instruction content information is possible (S103). In the case where the date which is indicated by the print instruction content information and on which the print instruction is issued does not exceed the expiration date indicated by the expiration date information, the controller 206 judges that the printing is possible, and when exceeds, a judgment that the printing is impossible is made.

By the above judgment, in the case where the printing is possible (S104: YES), the controller 206 inputs the image data to the printing section 205 and issues a print instruction, and performs control to cause the image based on the image data to be printed on the instant film 30 (S105). By this, the image based on the image data is printed on the instant film 30, and the instant film 30 is discharged from the discharge port 54.

By the above judgment, in the case where the printing is impossible (S104: NO), the controller 206 does not issue to the printing section 205 the print instruction of the image based on the image data the printing of which is instructed, creates notification information for notifying that the image based on the image data the printing of which is instructed can not be printed, and transmits it to the cellular phone 100 through the communication section 201 (S106). By this, on the display 102 of the cellular phone 100, such a display that ┌Since the expiration date of the film mounted in the printer has expired, the image instructed now can not be printed.┘ is produced. Incidentally, this notification may be performed at the portable printer 200 side, or can also be outputted as a sound.

As described above, according to the portable printer 200 of the third embodiment, in the case where the expiration date of the instant film 30 has expired, an image is not printed on the instant film. Thus, it is possible to prevent the occurrence of such a situation that an image is printed on the instant film the expiration date of which has expired and a photograph with degraded picture quality is formed.

Incidentally, in the third embodiment, although the propriety of printing is judged in the portable printer 200, this judgment may be made in the cellular phone 100. In this case, the controller 107 of the cellular phone 100 makes an acquisition request to the portable printer 200 for the expiration date information, and the controller 206 of the portable printer 200 transmits the expiration date information through the communication section 201 to the cellular phone 100 in response to this request. The controller 107 of the cellular phone 100 having acquired the expiration date information acquires the print instruction content information, and uses the acquired print instruction content information and the expiration date information to make a judgment as to the propriety of printing. When the printing is impossible, a predetermined display is produced on the display 102, and when the printing is possible, the image data is transmitted from the cellular phone 100 to the portable printer 200 and the printing is made to be performed.

In the first to the third embodiments, although the structure is such that the print medium characteristic information, such as the ID of the first character, the kind information, or the expiration date information, indicating the characteristics of the plural instant films 30 contained in the container 202 is stored in the wireless tag 35, and this is read by the wireless tag reader 203, the invention is not limited to this.

For example, instead of the wireless tag 35, a magnetic label is attached to the outside surface of the cover part 202b, and print medium characteristic information may be stored in this magnetic label. In this case, a magnetic read sensor is provided in the vicinity of the discharge port 54 of the portable printer 200, the print medium characteristic information is read by this magnetic read sensor, and the read print medium characteristic information is inputted to the controller 206.

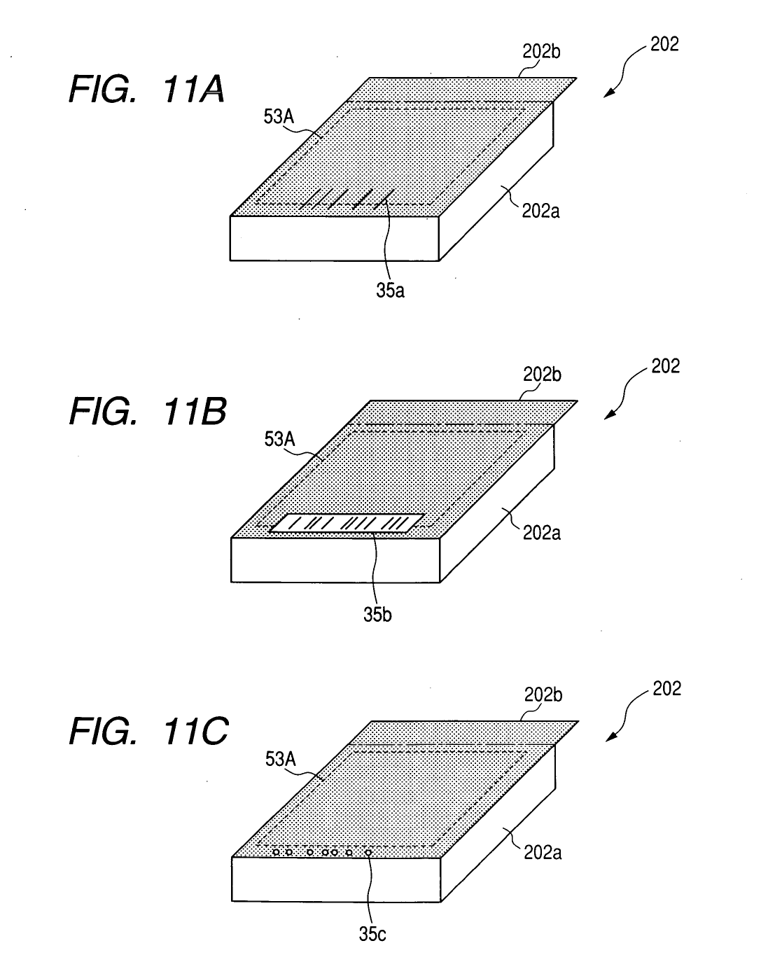

Alternatively, the structure may be such that instead of the wireless tag 35, plural linear projections 35a as shown in FIG. 11A are provided on the outside surface of the cover part 202b, and the print medium characteristic information is made to correspond to the arrangement pattern of the projections 35a and is stored. In this case, a projection detection sensor extending in the arrangement direction of the plural linear projections 35a is provided in the vicinity of the discharge port 54 of the portable printer 200, the print medium characteristic information is read by this projection detection sensor, and the read print medium characteristic information is inputted to the controller 206.

Alternatively, the structure may be such that instead of the wireless tag 35, a barcode label on which a barcode as shown in FIG. 11B is printed is pasted on the outside of the cover part 202b, and print medium characteristic information is made to correspond to the barcode and is stored. In this case, a line sensor extending in the arrangement direction of bars of the barcode is provided in the vicinity of the discharge port 54 of the portable printer 200, the print medium characteristic information made to correspond to the barcode is read by the line sensor, and the read print medium characteristic information is inputted to the controller 206. Incidentally, instead of the barcode, a two-dimensional code or a character code may be used. Alternatively, the structure may be such that instead of the barcode label, a color label is provided, and the print medium characteristic information is made to correspond to the color of the color label and is stored.

Alternatively, the structure may be such that instead of the wireless tag 35, plural holes 35c as shown in FIG. 11C are provided in the outside surface of the cover part 202b, and the print medium characteristic information is made to correspond to the arrangement pattern of the holes and is stored. In this case, a line sensor extending in the arrangement direction of the plural holes 35c is provided in the vicinity of the discharge port 54 of the portable printer 200, the print medium characteristic information made to correspond to the plural holes is read by this line sensor, and the read print medium characteristic information is inputted to the controller 206. Incidentally, the plural holes 35c are required to be provided at a portion not overlapping with the opening 53A of the containing part 202a so that the instant film 30 in the container 202 is not exposed to light.

Alternatively, the structure may be such that the print medium characteristic information stored in the wireless tag 35 is encrypted, and the acquired print medium characteristic information is decrypted in the controller 206. By doing so, it is possible to prevent the print medium characteristic information from being interpolated.

The storage section that performs the function of storing the print propriety table or other foregoing functions is not limited to a hard disk drive, and any well-known equivalent information storage structure may be employed. For example, but not by way of limitation, an optical or magnetic disk, a portable memory storage device but not limited thereto, a remote data storage system, or other data storage structure as would be known to one of ordinary skill in the art may be employed.

The controller that performs the function of judging the print propriety or other foregoing functions is not limited to a general purpose computer. As such, the controller may also include a computer-readable medium or a data carrier that contains instructions of the present invention.

FIG. 1

10 DIGITAL CONTENT DELIVERY SERVER
11 DIGITAL CONTENT DELIVERY SERVER
100 CELLULAR PHONE
200 PORTABLE PRINTER
   FIG. 2
107 CONTROLLER
1058 IMAGING SECTION
106 MEMORY
101 COMMUNICATION SECTION
102 DISPLAY
103 COMMUNICATION SECTION
104 SPEAKER
   FIG. 3
201 COMMUNICATION SECTION
203 WIRELESS TAG READER
202 CONTAINER
204 MEMORY
206 CONTROLLER
205 PRINTING SECTION
   FIG. 7
TABLE LETTER SYMBOL
FIRST CHARACTER ID
SECOND CHARACTER ID
PROPRIETY OF PRINTING
   FIG. 8
START
S81 ACQUIRE FIRST CHARACTER ID
S82 ACQUIRE PRINT INSTRUCTION CONTENT INFORMATION
S83 BASED ON ID OF FIRST CHARACTER, ID OF SECOND CHARACTER, AND PRINT PROPRIETY TABLE, JUDGE WHETHER PRINTING OF INSTRUCTED IMAGE CAN BE PERFORMED
S84 WHETHER PRINTING IS POSSIBLE?
S85 ISSUE PRINT INSTRUCTION TO CAUSE PRINTING TO BE PERFORMED
S86 TRANSMIT TO CELLULAR PHONE 100 INFORMATION NOTIFYING THAT PRINTING CAN NOT BE PERFORMED
END
   FIG. 9
START
S91 ACQUIRE KIND INFORMATION
S92 ACQUIRE PRINT INSTRUCTION CONTENT INFORMATION
S93 BASED ON KIND INFORMATION AND PRINT INSTRUCTION CONTENT INFORMATION, JUDGE WHETHER PRINTING OF INSTRUCTED IMAGE CAN BE PERFORMED
S94 WHETHER PRINTING IS POSSIBLE?
S95 ISSUE PRINT INSTRUCTION TO CAUSE PRINTING TO BE PERFORMED
S96 TRANSMIT TO CELLULAR PHONE 100 INFORMATION NOTIFYING PRINTING CAN NOT BE PERFORMED
END
   FIG. 10
S101 ACQUIRE EXPIRATION DATE INFORMATION
S102 ACQUIRE PRINT INSTRUCTION CONTENT INFORMATION
S103 BASED ON EXPIRATION DATE INFORMATION AND PRINT INSTRUCTION CONTENT INFORMATION, JUDGE WHETHER PRINTING OF INSTRUCTED IMAGE CAN BE PERFORMED
S104 WHETHER PRINTING IS POSSIBLE?
S105 ISSUE PRINT INSTRUCTION TO CAUSE PRINTING TO BE PERFORMED
S106 TRANSMIT TO CELLULAR PHONE 100 INFORMATION NOTIFYING THAT PRINTING CAN NOT BE PERFORMED
END

What is claimed is:

1. A print control apparatus comprising:
a print medium characteristic information acquisition unit that acquires print medium characteristic information indicating a characteristic of a print medium contained in a print medium container mounted in the printer;
a print instruction content information acquisition unit that acquires print instruction content information indicating a content of a print instruction of an image based on image data to the printer;
a judgment unit that makes a judgment about a propriety of printing the image based on the print medium characteristic information and the print instruction content information; and
an output unit that makes an output based on the judgment.

2. The print control apparatus according to claim 1, wherein
the print medium characteristic information includes first identification information to identify a first character previously printed on the print medium contained in the print medium container,
the print instruction content information includes second identification information to identify a second character included in the image data as a print object to the print medium, and
based on print propriety information indicating the propriety of printing the first character and the second character onto a same print medium, the first identification information, and the second identification information, the judgment unit makes a judgment about the propriety of printing the image based on the image data.

3. The print control apparatus according to claim 1, wherein
the print medium characteristic information includes print medium kind information indicating a kind of the print medium contained in the print medium container, and
the judgment unit judges that printing of the image based on the image data can not be performed in a case where a kind of a print medium most suitable for a printing condition indicated by the print instruction content information is not coincident with the kind of the print medium indicated by the print medium kind information.

4. The print control apparatus according to claim 1, wherein
the print medium characteristic information includes expiration date information indicating an expiration date of the print medium contained in the print medium container, and
the judgment unit judges that printing of the image based on the image data can not be performed in a case where a date when the print instruction indicated by the print instruction content information is issued exceeds the expiration date indicated by the expiration date information.

5. A printer comprising:
the print control apparatus according to claim 1;
a housing part that houses the print medium container; and
a reading unit that reads the print medium characteristic information from a storage medium provided at the print medium container housed in the housing part, wherein
the print instruction content information acquisition unit acquires the print instruction content information from a portable terminal apparatus, and
the print medium characteristic information acquisition unit acquires the print medium characteristic information from the reading unit.

6. The printer according to claim 5, wherein
the print medium characteristic information includes first identification information to identity a first character previously printed on the print medium contained in the print medium container,
the print instruction content information includes second identification information to identify a second character included in the image data as a print object to the print medium, and
based on print propriety information indicating the propriety of printing the first character and the second character onto a same print medium, the first identification information, and the second identification information, the judgment unit makes a judgment about the propriety of printing the image based on the image data.

7. The printer according to claim 6, which further comprises a storage unit that previously stores the print propriety information.

8. The printer according to claim 6, which further comprises a print propriety information acquisition unit that acquires the print propriety information from the portable terminal apparatus.

9. The printer according to claim 5, wherein
the print medium container includes: a containing part that contains the print medium; and a cover part that covers the print medium contained in the containing part and can be detached from the containing part,
the storage medium is provided at the cover part, and
the reading unit is located in a vicinity of a discharge port for discharging the print medium to an outside of the printer, and reads the print medium characteristic information from the storage medium attached to the cover part when the cover part is removed from the discharge port to the outside in a state where the print medium container is housed in the housing part.

10. The printer according to claim 6, wherein
the print medium container includes: a containing part that contains the print medium; and a cover part that covers the print medium contained in the containing part and can be detached from the containing part,
the storage medium is provided at the cover part, and
the reading unit is located in a vicinity of a discharge port for discharging the print medium to an outside of the printer, and reads the print medium characteristic information and the print propriety information from the storage medium attached to the cover part when the cover part is removed from the discharge port to the outside in a state where the print medium container is housed in the housing part.

11. The printer according to claim 5, wherein the storage medium includes a wireless tag.

12. The printer according to claim 5, wherein the storage medium includes a magnetic label.

13. The printer according to claim 5, wherein the storage medium includes plural linear projections.

14. The printer according to claim 5, wherein the storage medium includes a barcode label.

15. The printer according to claim 5, wherein the storage medium includes plural holes.

16. A print control apparatus comprising:
means for acquiring print medium characteristic information indicating a characteristic of a print medium contained in a print medium container mounted in the printer;
means for acquiring print instruction content information indicating a content of a print instruction of an image based on image data to the printer; and
means for making a judgment about a propriety of printing the image based on the print medium characteristic information and the print instruction content information; and
means for making an output based on the judgment.

17. The print control apparatus according to claim 16, wherein
the print medium characteristic information includes first identification information to identify a first character previously printed on the print medium contained in the print medium container,
the print instruction content information includes second identification information to identify a second character included in the image data as a print object to the print medium, and
the means for judging judges the propriety of printing the first character and the second character onto a same print medium, the first identification information, and the second identification information.

18. The print control apparatus according to claim 16, wherein
the print medium characteristic information includes print medium kind information indicating a kind of the print medium contained in the print medium container, and
the means for judging judges that printing of the image based on the image data can not be performed in a case where a kind of a print medium most suitable for a printing condition indicated by the print instruction content information is not coincident with the kind of the print medium indicated by the print medium kind information.

19. The print control apparatus according to claim 16, wherein
the print medium characteristic information includes expiration date information indicating an expiration date of the print medium contained in the print medium container, and
the means for judging judges that printing of the image based on the image data can not be performed in a case where a date when the print instruction indicated by the print instruction content information is issued exceeds the expiration date indicated by the expiration date information.
